(19) United States
(12) Patent Application Publication
(10) Pub. No.: US 2025/0275506 A1
(43) Pub. Date: Sep. 4, 2025

(54) MODULAR FARM AND METHODS OF MAKING AND USE THEREOF

(71) Applicant: Freight Farms, Inc., Boston, MA (US)

(72) Inventors: Derek BAKER, Boston, MA (US); Jacob FELSER, Boston, MA (US); Jonathan FRIEDMAN, Boston, MA (US); Alexander LOCKE, Boston, MA (US)

(21) Appl. No.: 18/858,703

(22) PCT Filed: Apr. 24, 2023
(86) PCT No.: PCT/US2023/066107

§ 371 Date: Oct. 21, 2024

Related U.S. Application Data
(60) Provisional application No. 63/333,777, filed on Apr. 22, 2022.

(51) Int. Cl. A01G 9/24; A01G 9/02; A01G 9/029; A01G 9/26

(52) U.S. Cl. CPC A01G 9/247; A01G 9/022; A01G 9/029; A01G 9/26

(57) ABSTRACT

Systems and methods for manufacturing a container farm including a cultivation module and a support module. The cultivation module includes at least one first plant support apparatus configured to receive one or more plants having a first configuration. The support module includes an irrigation system configured to provide a mixture of water and nutrients to the at least one plant support apparatus; and a climate control system comprising components of a heating, ventilation, and air conditioning (HVAC) system. The at least one first plant support apparatus is configured to be exchanged with at least one second plant support apparatus configured to receive one or more plants having a second configuration different than the first configuration or one of the components of the HVAC system is configured to be replaced with a different component of the HVAC system.

### CROSS-REFERENCE TO RELATED APPLICATIONS

This application claims the benefit of U.S. Provisional Patent Application No. 63/333,777, filed Apr. 22, 2022, and hereby incorporates by reference herein the contents of this application in their entirety.

### BACKGROUND

The need for fresh food is growing as the population increases and climate change impacts crop growing seasons. The current food supply model, based on traditional farming methods and long distance shipping, is economically and environmentally unsustainable. Traditional farming operations are usually located in agricultural areas, which require large upfront costs, large acreage and have high operational costs from seed to sale. Therefore, there is a need for efficient farming systems and methods, and improvements thereto.

Urban and local agriculture face obstacles in providing space for growing plants. Space for farming is limited in cities and rarely sufficient to meet a high demand. High start-up and operating costs of greenhouses make local crop production difficult. Structures intended to support rooftop greenhouses, for example, must be evaluated by structural engineers and often require additional bracing to support the extra weight. Urban gardens often must address contaminated soil. Hydroponic systems are not easily used in urban locales, as most hydroponic systems are meant to be installed in agricultural settings, are not easily transportable, and require extensive training of personnel for operation. Thus, self-contained agricultural systems have recently been developed for generating high-yield crops. Such self-contained systems may be located in unused buildings, such as warehouses, or in specialized or repurposed closed or semi-closed environments and often utilize vertically oriented plant arrangements.

### SUMMARY

In one example approach, such systems may be contained, such as within a modular container or other farm housing, which may be mobile, and may include a growing system that includes various features to support agricultural production, such as a plurality of plant support apparatuses (e.g., plant panels) to hold the growing plants, a lighting system to provide appropriate light for the plants, an irrigation system to provide nutrients to the plants, a climate control system to control the environmental conditions within the container, a ventilation system for providing airflow to the plants, and a system to monitor and control the components of the growing system.

In some aspects, such systems may include a cultivation module and a support module, each of which may include components that can be changed based on a type of plants grown in the farm container. For example, different models of plant support apparatus may be interchangeably used with the cultivation module. Such plant support apparatuses may include plant support apparatuses that have substantially vertical plant channels configured to grow leafy green plants and plant support apparatuses that have substantially horizontal shelves that may be used to grow plants such as tomatoes, cannabis, and/or strawberries, among others. In some aspects, the support module may include one or more components of heating, ventilation, and air conditioning (HVAC) systems, which may be interchangeably used based on the types of plants to be grown.

In some aspects, a seedling subscription system may provide plant seedlings to a user of the farm container on an on-demand basis. For example, the seedling subscription system may determine that plants in a particular user's container farm are ready for harvest and/or have been harvested. The seedling subscription system may then send new seedlings to the customer. This may be advantageous because it may reduce the amount of work to be performed by the user of the farm container because the user does not need to germinate their own seeds and only needs to focus on growing seedlings into harvestable plants. The seedling subscription service may reduce the complexity of the farm container because the cultivation module of the farm container does not need to include any components optimized for germination of seedlings. Further, since the subscription service may be aware of the specific types of seeds germinated into seedlings and how these seedlings are grown, the seedling service can provide dry/soluble nutrient recipes configured to produce desired characteristics in the mature plants and the produce grown from these seedlings.

Examples of various such features are shown and described with respect to U.S. Pat. No. 10,271,486 titled Insulated Shipping Containers Modified for High-Yield Plant Production Capable in Any Environment, issued Apr. 30, 2019; U.S. Pat. No. 11,026,380 titled Vertical Assembly for Growing Plants, Jun. 8, 2021; U.S. Pat. No. 10,785,925 titled Insulated Shipping Containers Modified for High-Yield Fungi Production Capable in Any Environment, issued Sep. 29, 2020; U.S. Patent Publication No. 2019/0133026 titled Modular Farm Control and Monitoring System, published May 9, 2019; U.S. Patent Publication No. 2020/0037524 titled Modular Farm with Carousel System, published Feb. 6, 2020; and U.S. Patent Publication No. 2020/0359569 titled Hub and Spoke Modular Farm System, published Nov. 19, 2020, each of the foregoing of which is hereby incorporated herein by reference in its entirety.

Additional advantages and novel features of these aspects will be set forth in part in the description that follows, and in part will become more apparent to those skilled in the art upon examination of the following upon learning by practice of the disclosure.

### BRIEF DESCRIPTION OF THE FIGURES

FIG. 1 illustrates an example container farm for plant production having doors in a closed position, in accordance with various features of the present disclosure.

FIG. 2 illustrates a perspective view of the container farm of FIG. 1 having doors in the closed position, in accordance with various features of the present disclosure.

FIG. 3 illustrates a perspective view of the container farm of FIG. 1 having doors in an open position, in accordance with various features of the present disclosure.

FIG. 4 illustrates a side view of the container farm of FIG. 1, in accordance with various features of the present disclosure.

FIG. 5 illustrates a detail view of a side of the container farm of FIG. 1 and an example accessory configured to engage the side of the container farm of FIG. 1, in accordance with various features of the present disclosure.

FIG. 5A illustrates a detail view of the side of the container farm of FIG. 1 engaged with the example accessory of FIG. 5, in accordance with various features of the present disclosure.

FIG. 6 illustrates a detail view of the side of the container farm of FIG. 1 coupled with other example accessories, in accordance with various features of the present disclosure.

FIG. 7 illustrates another example container farm for plant production, in accordance with various features of the present disclosure.

FIG. 8 illustrates a section view of the farm container of FIG. 1, taken along lines 8-8 of FIG. 2.

FIG. 9 illustrates a front perspective view of a cultivation module and a support module of the container farm of FIG. 1, in accordance with various aspects of the present disclosure.

FIG. 10 illustrates a rear perspective view of the cultivation module and the support module of the container farm of FIG. 1, in accordance with various aspects of the present disclosure.

FIG. 11 illustrates an example plant support apparatus of the container farm of FIG. 1, in accordance with various aspects of the present disclosure.

FIG. 12 illustrates an example light panel of the container farm of FIG. 1, in accordance with various aspects of the present disclosure.

FIG. 13 illustrates a detail view of a nutrient dosing and monitoring system of the container farm of FIG. 1, in accordance with various aspects of the present disclosure.

FIG. 14 illustrates a front view of an example support module of the container farm of FIG. 1 in accordance with various aspects of the present disclosure.

FIG. 15 illustrates an example display screen of a graphical user interface of the container farm of FIG. 1, in accordance with various aspects of the present disclosure.

FIG. 15A illustrates another example display screen of a graphical user interface of the container farm of FIG. 1, in accordance with various aspects of the present disclosure.

FIG. 15B illustrates another example display screen of a graphical user interface of the container farm of FIG. 1, in accordance with various aspects of the present disclosure.

FIG. 16 illustrates an example method for providing seedlings to a user of the container farm, in accordance with various aspects of the present disclosure.

FIG. 17 illustrates a display screen of a graphical user interface of an example crop planning feature of the container farm of FIG. 1, in accordance with various aspects of the present disclosure.

FIG. 17A illustrates a display screen of a graphical user interface of an example crop planning feature of the container farm of FIG. 1, in accordance with various aspects of the present disclosure.

FIG. 18 illustrates a display screen of a graphical user interface of an example recipe planning feature of the container farm of FIG. 1, in accordance with various aspects of the present disclosure.

FIG. 19 shows an example system diagram of various hardware components and other features for use with the farm container of FIG. 1, according to aspects of the present disclosure.

FIG. 20 shows a representative block diagram of various example system components for use with the farm container of FIG. 1, according to aspects of the present disclosure.

### DETAILED DESCRIPTION

Aspects of the present disclosure relate to improvements and/or enhancements to various features of an agricultural growing system, including, but not limited to a cultivation module and a support module for a farm container that include components that can be changed based on a type of plants grown in the farm container, an improved irrigation system, and/or a seedling subscription system that may provide plant seedlings to a user of the farm container on an on-demand basis, as well as other benefits.

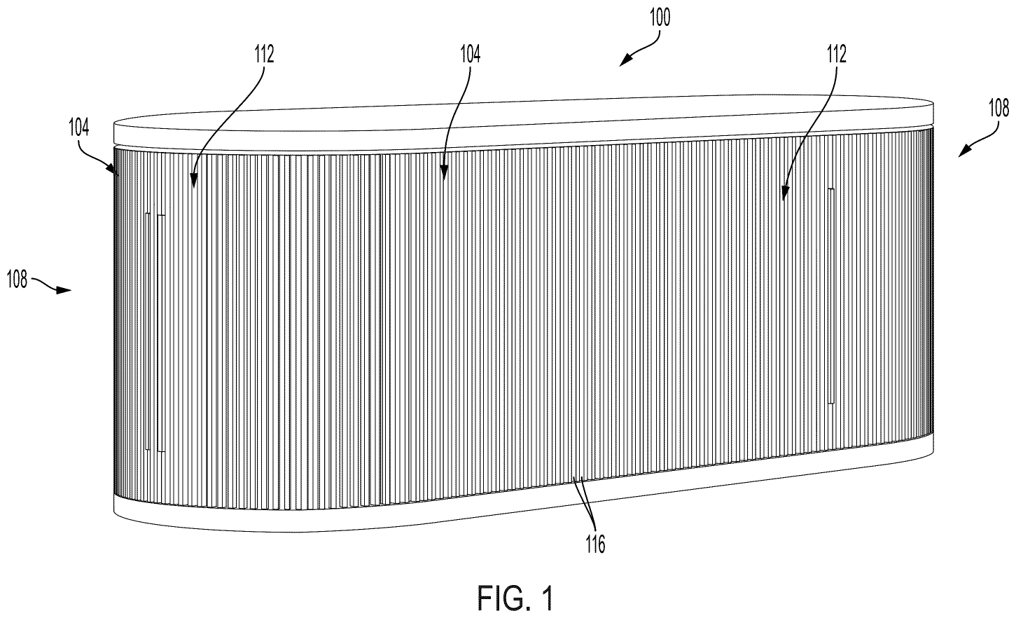

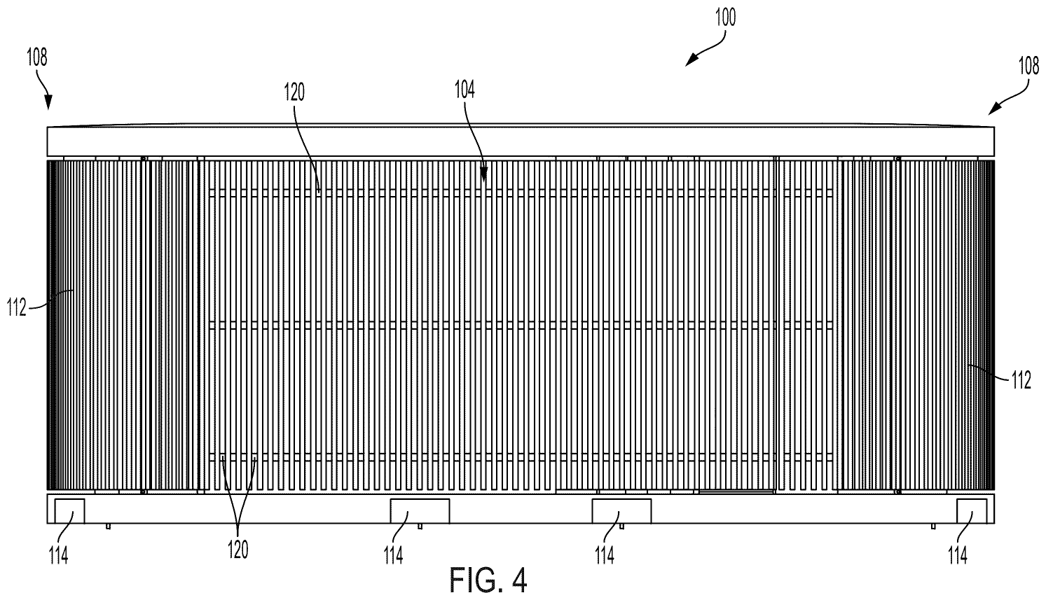

FIGS. 1-4 illustrate a farm container 100 in accordance with some aspects of the present disclosure. The farm container 100 may be mobile, and may comprise a self-contained system for growing plants. For example, the farm container 100 may be repositioned from a first location to a second location. In some aspects, the farm container 100 may be sized for non-industrial use, such as consumer use (e.g., home use), restaurant use, and so forth.

In some aspects, the farm container 100 may have an elongated shape with curved ends. In such aspects, the farm container 100 may have substantially parallel, substantially linear side walls 104 when viewed from above and/or below, and semi-circular ends 108. In other aspects, the farm container 100 may have a different cross-sectional shape, such as a rectangle, ellipse, square, and so forth.

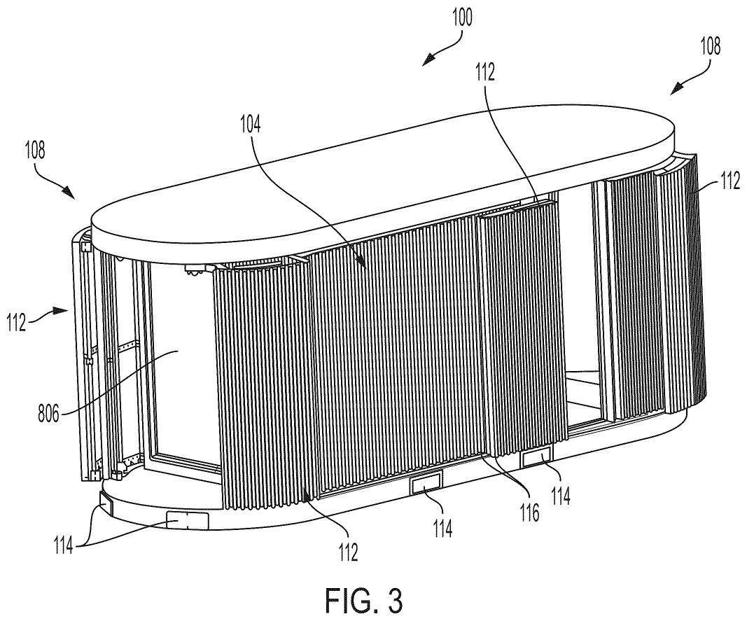

The farm container 100 may include doors 112. In some aspects, the doors 112 may be positioned at ends 108 of the farm container 100. In aspects in which the ends 108 are curved, the doors 112 may also be curved. In some aspects, the farm container 100 may include doors 112 at other locations, such as along a sidewall of the farm container 100. In some aspects, the doors 112 may be sliding doors that generally conform to a cross-sectional shape of the farm container 100 when the doors 112 are in the open configuration, as shown for example in FIG. 3. The doors 112 may be positioned to provide access to an interior growing space of the farm container 100, provide access to electrical and/or mechanical systems of the farm container 100, and/or provide access to storage compartments 804 of the farm container 100.

The farm container 100 may include holes 114. The holes 114 may be pairs of holes that can be engaged by a forklift to move the farm container 100 to a different location. In some aspects, the holes 114 may be positioned at each end 108 of the farm container 100 and/or proximate a center of the farm container 100. In some aspects, such as the variant shown in FIGS. 1-4, the holes 114 may be covered when the farm container 110 is not being moved.

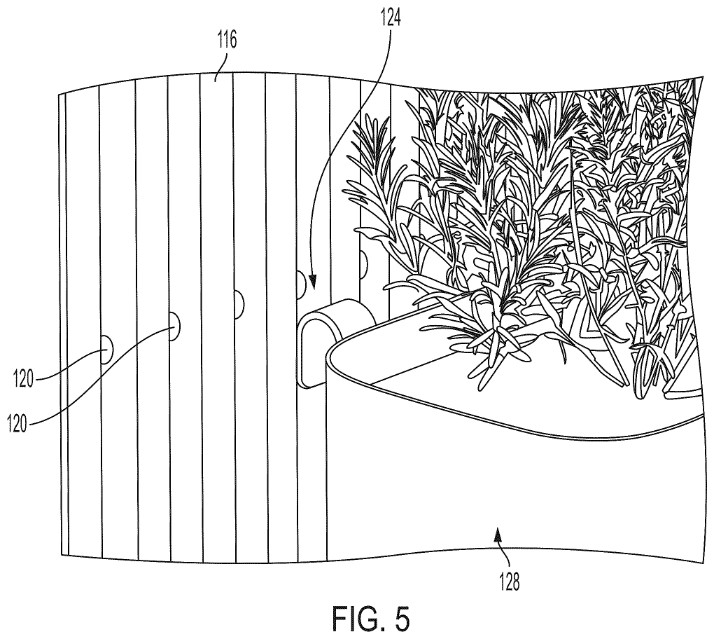

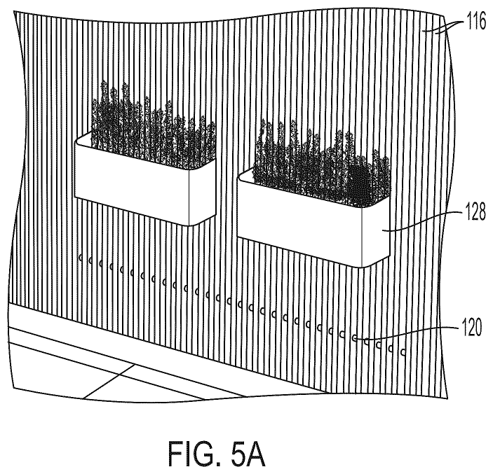

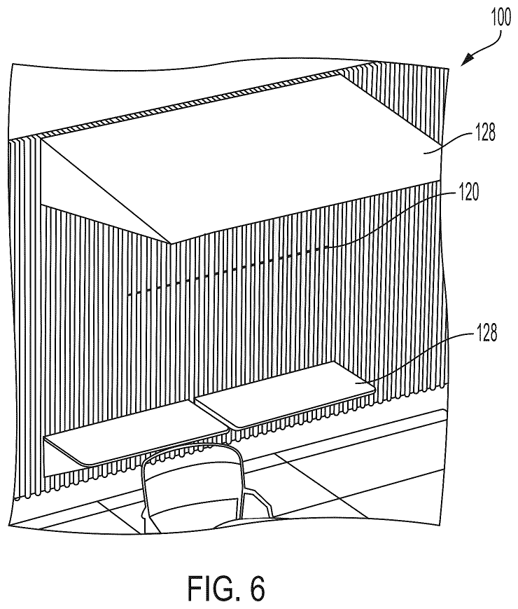

In some aspects, the sidewalls 104 of the farm container 100 may include a plurality of slats 116. In some aspects, the farm container 100 may include a plurality of mounting poles 120 that may be mounted to the substantially linear sidewalls 104. In the illustrated variation, the farm container 100 may include three mounting poles 120 at different heights along the sidewall 104, such that accessories can be mounted at different heights. In some aspects, the mounting poles 120 may extend through the slats 116. The mounting poles 120 may be engaged by mounting hooks 124 of accessories 128 that may be hung from the farm container 100. For example, FIG. 5 illustrates a detail view of the mounting hook 124 of the example accessory 128 aligned with one of the mounting poles 120. The mounting hook 124 can be coupled with the mounting pole 120 to mount the accessory 128 to the sidewall 104. For example, FIG. 5A illustrates example accessories 128 coupled to the sidewall 104 of the farm container 100. In the aspect illustrated in FIG. 5A, the accessory 128 may be a flower pot. In other aspects, such as the example aspect shown in FIG. 6, the accessory 128 may include an awning and/or a support surface, such as a countertop or a table.

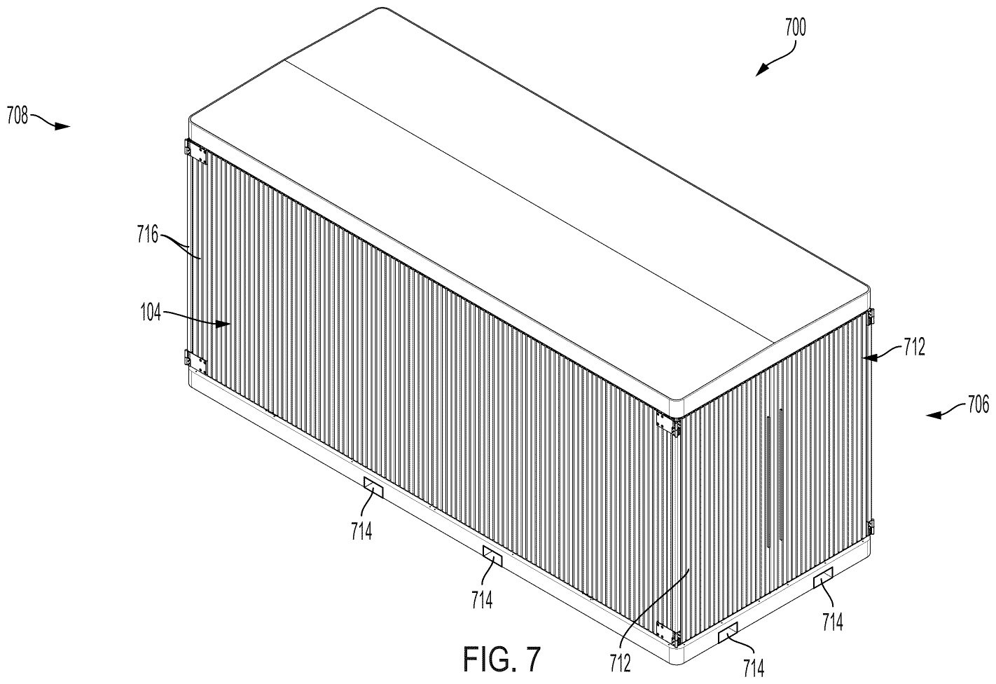

FIG. 7 illustrates a farm container 700 in accordance with some aspects of the present disclosure. The farm container 700 is substantially similar to the farm container 100 and is only described in detail herein insofar as it has minor differences from the farm container 100. Like numbers are used to refer to like parts between the farm container 700 and the farm container 100.

In some aspects, the farm container 700 may have an elongated, rectangular shape. In other aspects, the farm container 100 may have a different cross-sectional shape, such as a rectangle, ellipse, square, and so forth.

In some aspects, the doors 712 may utilize a 4-bar linkage to open the entire surface of the door 712 at first in a manner substantially perpendicular to the cross-sectional shape of the farm container 700, and then as the doors 712 open to allow the doors 712 to move back and tuck closely into the shape of the farm container 700 clear of the opening in the farm container 700 previously covered by the doors 712.

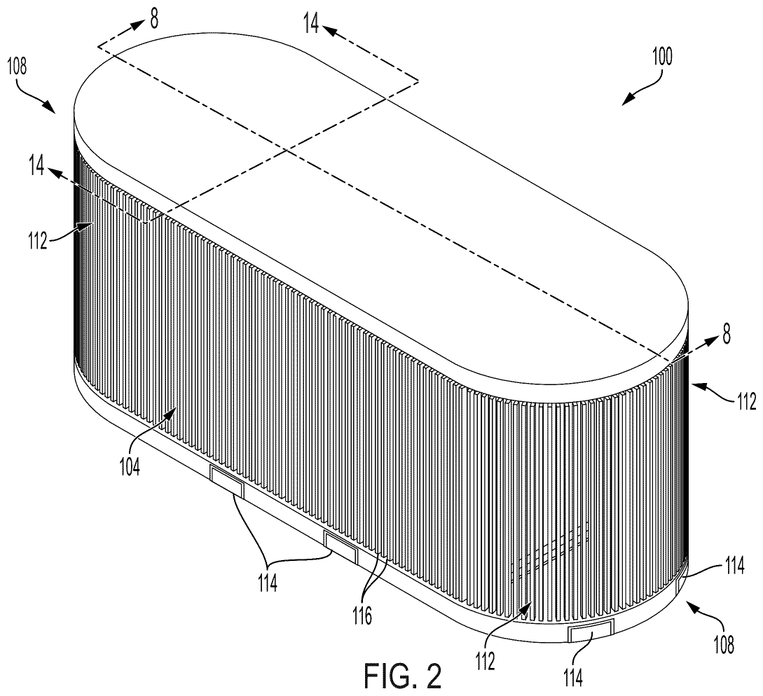

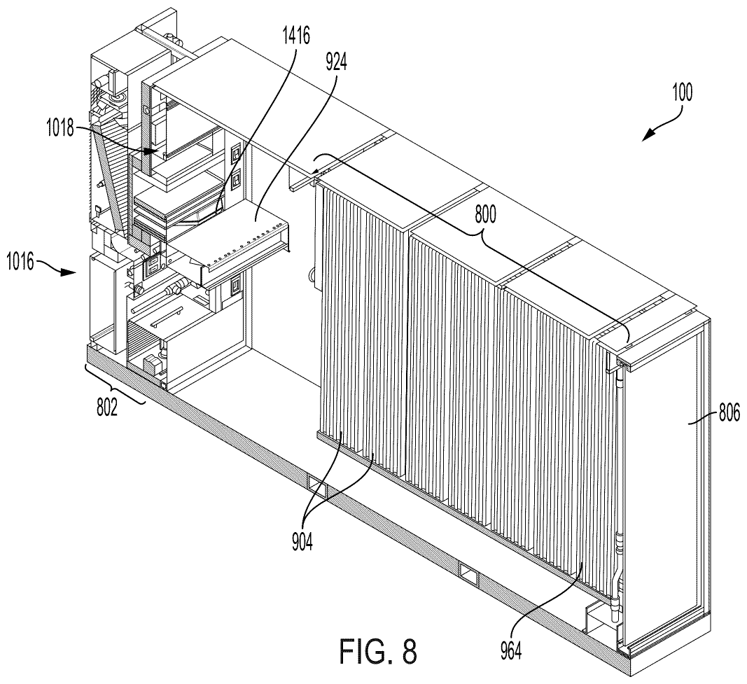

FIG. 8 illustrates a section view of the farm container 100 taken along lines 8-8 of FIG. 2. As shown in FIG. 8, the farm container 100 may include a cultivation module 800 and a support module 802. As is discussed in greater detail below, the cultivation module 800 may include the various subsystems required to grow plants in the farm container 100. In some aspects, the shape of the perimeter of the cultivation module 800 and/or the support module 802 may be different from the shape of the perimeter of the farm container 100. In such aspects, the farm container 100 may include one or more storage compartments 804. In some aspects, one or more of the doors 112 may be positioned to provide access into the storage compartments 804 from outside of the farm container 100. In some aspects, a wall 806 of the one or more of the storage compartments 804 may be transparent or semi-transparent. In such aspects, the wall 806 may allow the cultivation module 800, the support module 802, and components thereof to be viewed from the storage compartment 804 and/or the outside environment of the container 100. In some aspects, one or more of the storage compartments 804 may be positioned to allow access to systems of the cultivation module 800 for maintenance. In some aspects, the farm container 100 may be configured to receive different types of cultivation modules 800 and support modules 802 therein. The different types of cultivation modules 800 and support modules 802 may be customized for the cultivation needs of particular groups of plants or particular types of plants.

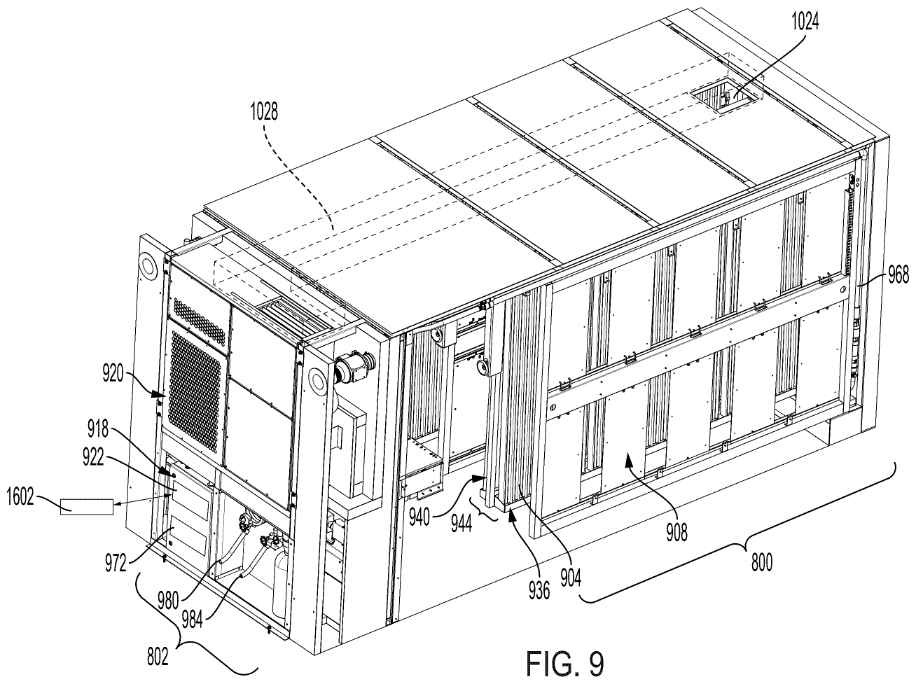

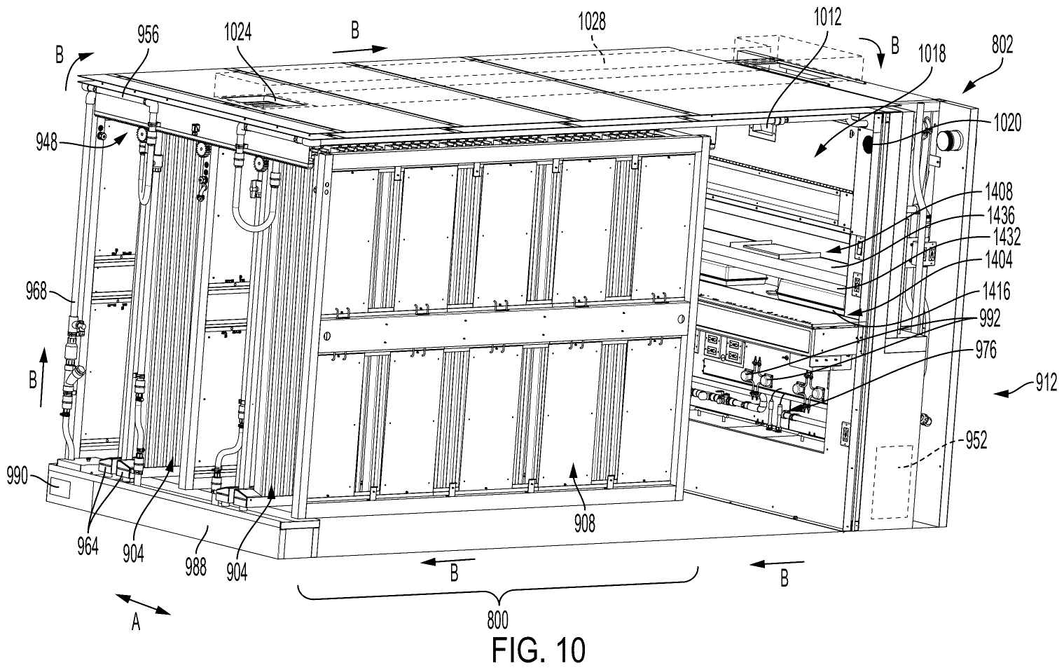

FIG. 9 illustrates a front perspective view of the example cultivation module 800 and support module 802. FIG. 10 illustrates a rear perspective view of the example cultivation module 800 and support module 802. As shown in FIGS. 8-10, the cultivation module 800 may include one or more plant support apparatuses 904, one or more light panels 908, and components of an irrigation system 912, an electrical system 918, and a climate control system 920, among other components. The support module 802 may include components of the irrigation system 914, components of the electrical system 918, components of the climate control system 920, a control system 922, and a user workspace 924, among other components. In some aspects, the work space 924 may be or include a work surface. In some aspects, the support module may include a germination zone 1404 and a nursery zone 1408.

In some aspects, details of various features that may be included the cultivation module 800 and/or the support module are shown and described in U.S. Pat. No. 10, 271,486, titled Insulated Shipping Containers Modified for High-Yield Plant Production Capable in Any Environment, filed Mar. 22, 2016, U.S. Patent Publication No. 2019/0133026 titled Modular Farm Control and Monitoring System, which is the national phase application of a PCT application filed on Apr. 4, 2017, and/or U.S. patent application Ser. No. 17/546,333 titled Systems and Methods for Controlling and Monitoring Farms, filed Dec. 9, 2021, all of which are incorporated herein by reference in relevant part.

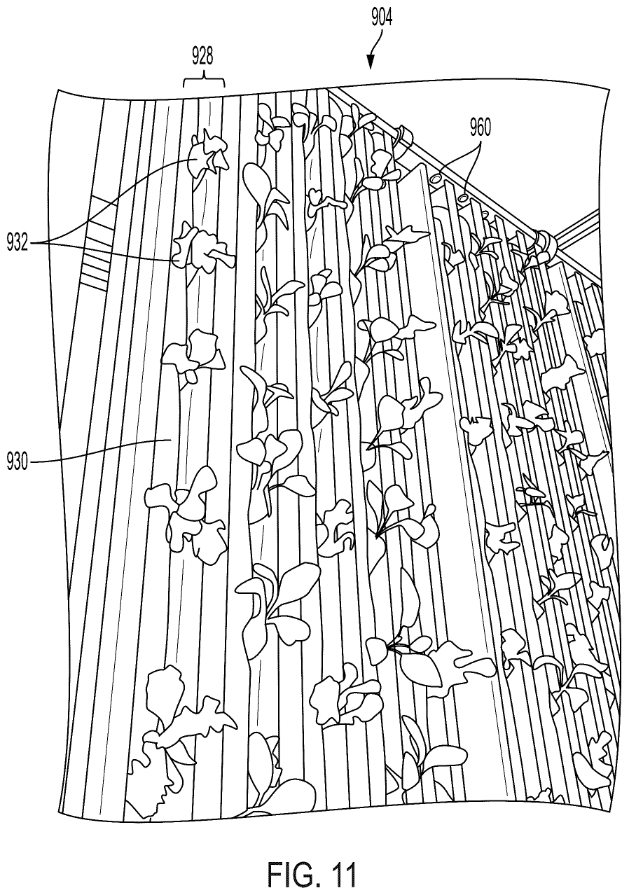

The plant support apparatuses 904 are configured to receive plant seedlings and provide nutrients and water (e.g., via the irrigation system 912) to the plants 932 as the plants 932 grow. In some aspects, such as the example plant support apparatus 904 shown in FIG. 11, the plant support apparatuses 904 include generally vertically-oriented grow channels 928 configured to receive and orient plants 932 in a generally vertical configuration as the plants 932 grow. In some aspects, the vertical configuration may be used to grow lettuce, herbs, and other types of leafy green plants.

In some aspects, a plant support substrate or support medium 930 may be located within each channel. In one aspect, the plant support substrate 930 can be a single piece of material having a continuous slit or a plurality of discrete slits along its length in alignment with the grow channels 928, or can be formed from two pieces of material compressed together. In another aspect, the plant support 930 substrate can be formed by a series of individual plant holders coupled to the grow channels 928. In some aspects, he plant support substrate 930 can be retained within the channel by the resiliency of the channel walls compressing against the plant support substrate 930. In some aspects, seedling plugs can be placed in the slit or slits within or between the support medium 930, as shown for example in FIG. 11. In other aspects, seedling plugs can be planted in the individual plant holders. A mixture of water and nutrients from the irrigation system 912 may be fed into each grow channel 928 through the open top end and drips out the open bottom end, irrigating the plants within the grow channel 928 as it flows downwardly through the plant support substrate 930.

In some aspects, the plant support substrate 930 can be an open cell foam or matrix material with a large pore volume. In some variations, the open cell foam material is a polyurethane or a polyether. Other open cell foam materials can be used, such as polyethylene, polyethylene terephthalate, polypropylene, polystyrene, polyvinyl chloride, and polyester. In some aspects, the material can be treated, for example, with a silicone binder or coating, to minimize contact between the nutrient solution and the material. Other types of plant support media can be used, such as a fibrous growth material or individual plant holders made from thermoplastic or thermoset material.

In some aspects, details of various features that may be included in such a plant support apparatuses 904 are shown and described in U.S. patent application Ser. No. 17/933,309 titled Vertical Farming Watering System and Methods of Making and Use Thereof, filed Sep. 19, 2022, the entirety of which is incorporated by reference herein.

In other aspects, the plant support apparatuses 904 may include one or more shelves configured to orient plants in a horizontal configuration. In such aspects, the plants may be disposed in hanging shelves or other containers. The mixture of water and nutrients provided by the irrigation system 912 may be deposited into the one or more shelves and be provided to the plants through the one or more slits. In some aspects, the plant support apparatuses 904 may include one or more trays configured to orient plants in a horizontal configuration. In such aspects, the plants may grow in containers in fluid communication with the trays. The trays may be periodically filled, emptied, and refilled with the mixture of water and nutrients, which the plants may then absorb through their containers.

As shown in FIGS. 9-10, the plant support apparatuses 904 may be oriented on first and second sides 936, 940 of a plant support apparatus support structure 944. In some aspects, the cultivation module 800 may include two plant support apparatus support structures 944, as shown, for example in FIGS. 9 and 10. In other aspects, the cultivation module 800 may include more or fewer plant support apparatus support structures 944. In some aspects, the plant support apparatus support structure 944 may be movably coupled within the cultivation module 800. For example, as is best shown in FIG. 10, the plant support apparatus support structures 944 may be mounted to a repositioning system 948. In some aspects, the repositioning system 948 may be configured to move the plant support apparatus support structures 944 in the direction shown by the arrow A (FIG. 10), which may provide more workspace near the plant support apparatuses 904. In some aspects, the repositioning system 948 may include a rack-and-pinion system. In some aspects, the repositioning system 948 may be manually-actuated. In some aspects, the repositioning system 948 may be actuated by a motor.

In some aspects, the plant support apparatuses 904 and/or the plant support apparatus support structures 944 may be changed based on the type of plants grown in the farm container 100. For example, plant support apparatuses 904 with substantially vertical grow channels 928 may be used to grow leafy greens and plant support apparatuses 904 with horizontal shelves may be used to grow plants like strawberries, tomatoes, and cannabis, among others.

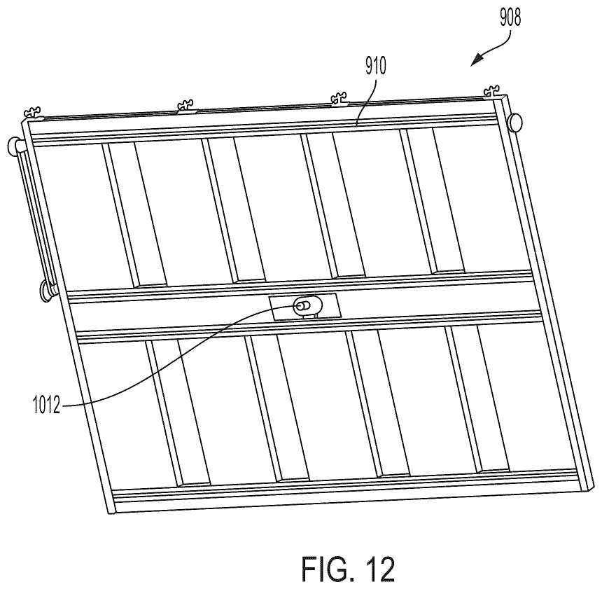

FIG. 12 illustrates an example light panel 908 according to some aspects of the present disclosure. As shown in FIG. 12, each light panel 908 may include a plurality of lights and a camera 1012. In some aspects, the light panels 908 may include LED lights. In other aspects, the light panels 908 may have other types of lights, such as incandescent, fluorescent, and so forth. In some aspects, the light panels 908 include alternately spaced banks of red and blue lights. In some aspects, each light panel 908 may include at least one work light 910 configured to illuminate the workspace for an operator. In some aspects, the work light 910 may be a LED strip light positioned proximate to the top of the light panel 908.

Once the seedlings in the nursery zone 1408 are mature enough to plant in the plant support apparatuses 904, an operator may uncouple a portion of the plant support apparatuses 904 from the plant support apparatus support structure 944, lie the plant support apparatuses 904 on the work surface 924, plant the seedlings within the grow channels 928 of the plant support apparatuses 904, and then re-mount the plant support apparatuses 904 to the plant support apparatus support structure 944.

With continued reference to FIGS. 9 and 10, the cultivation module 800 may include one or more light panels 908. For example, in the illustrated aspect, the cultivation module 800 includes three light panels 908. The light panels 908 are configured to provide light to the plants in the plant support apparatuses 904. The light panels 908 may be coupled at or proximate ends of the cultivation module 800 so that the plant support apparatuses 904 are adjacent the walls of the farm container 100 when the cultivation module 800 is positioned inside the farm container 100. In aspects in which the cultivation module 800 includes two or more plant support apparatuses 904, one or more light panels 908 may be positioned between adjacent plant support apparatuses 904. In such aspects, both sides of the light panels 908 may include lights. In aspects in which light panels 908 are positioned between adjacent plant support apparatuses 904, the light panels 908 positioned between adjacent plant support apparatuses 904 may also be coupled to the repositioning system 948.

In some aspects, the control system 922 may be configured to operate the light panels 908 according to a predefined schedule, for example to mimic day and night. In some aspects, the control system 922 may be configured to control an amount of light based on a point in the lifecycle and/or a species of plant being grown.

The one or more cameras 1012 may be configured to capture images of the plants growing in the plant support apparatuses 904. For example, a camera 1012 (FIG. 12) may be coupled to each of the light panels 908 facing the plant support apparatus(es) 904 adjacent to each particular light panel 908. For example, the camera 1012 may be coupled to the light panel 908 proximate a center of the light panel 908. In some aspects, cameras 1012 may be mounted elsewhere, such as, for example, to a wall of a bulkhead compartment 1016 (FIG. 8). In some aspects, the camera 1012 may be a wide angle camera or an ultrawide angle camera. In some aspects, the camera 1012 may be configured to capture 80% or more of the plants growing in the opposite plant support apparatus 904.

The cameras 1012 may be operable to capture image data of the plants in the plant support apparatuses 904. In some aspects, the cameras 1012 may be configured to capture image data in the visual light spectrum, the infrared (IR) light spectrum, and/or both the visual light and the IR light spectra.

In aspects which include the germination zone 1404 and/or the nursery zone 1408, one or more cameras 1012 may be mounted within the germination zone 1404 and/or the nursery zone 1408. In such aspects, the cameras 1012 may be operable to capture image data of the germinating seedlings in the germination zone 1404 and/or the seedlings in the nursery zone 1408.

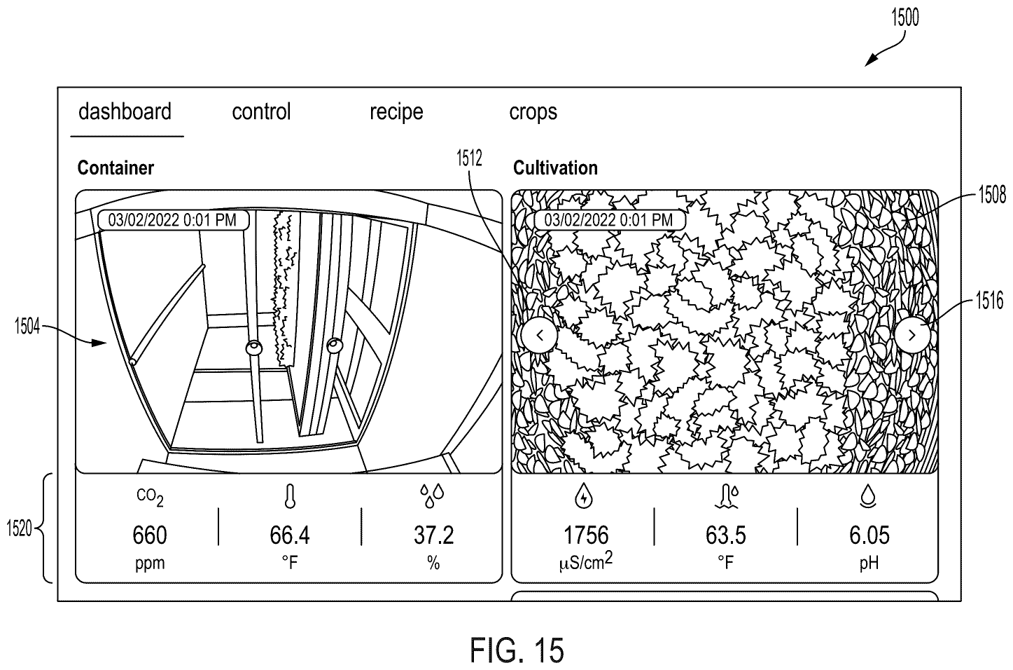

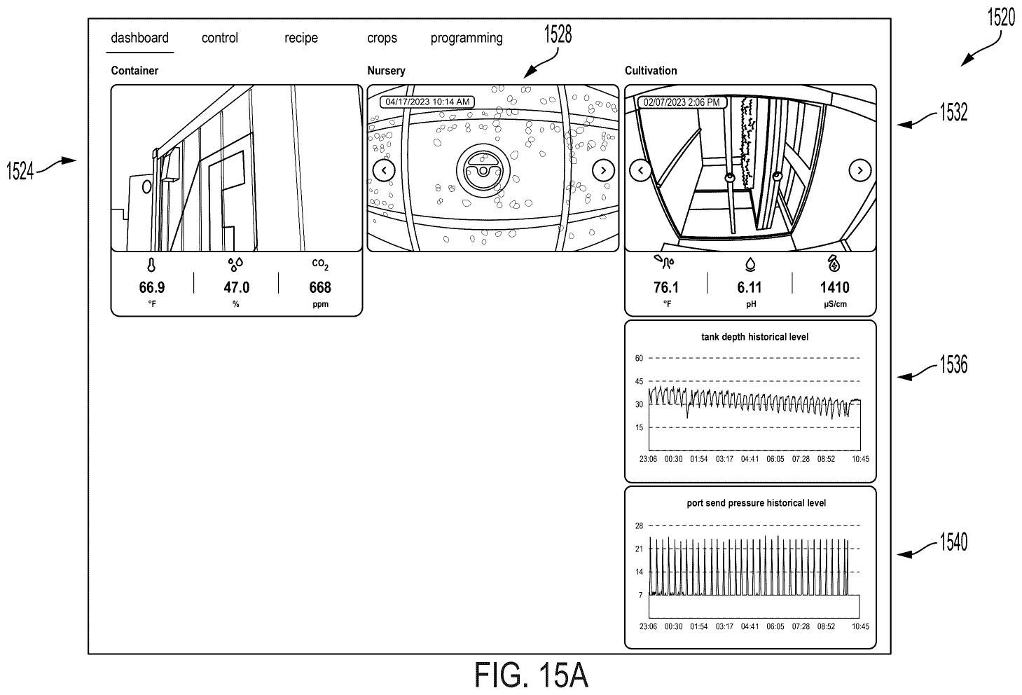

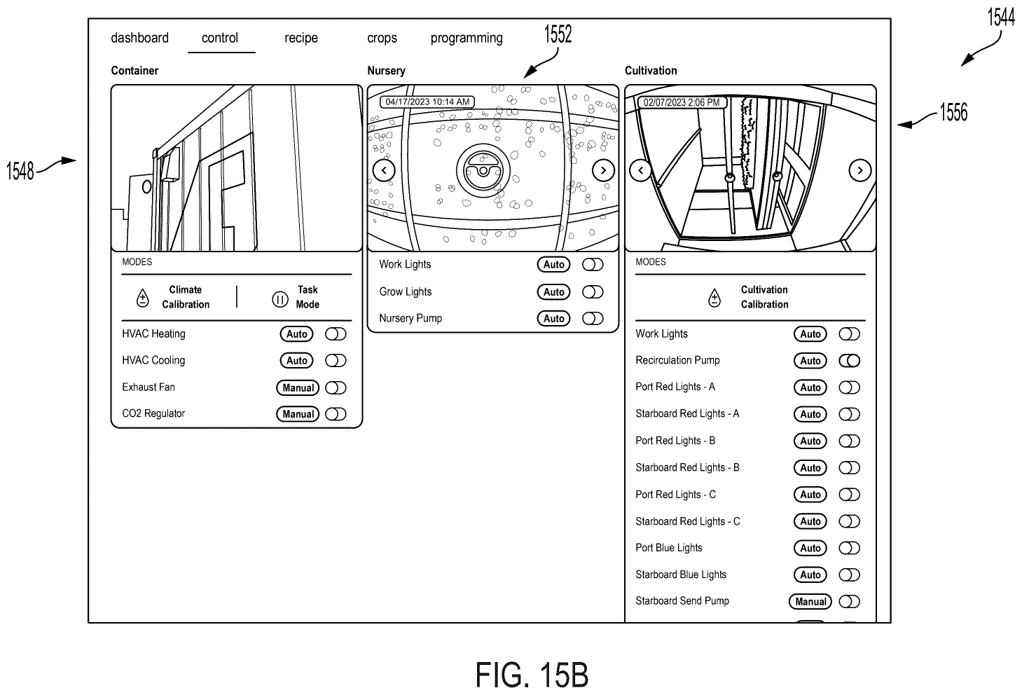

In some aspects, the cameras 1012 may be configured to transmit the captured image data of the plants and/or seedlings to a display of a user input/output interface, as shown for example in FIG. 15. In some aspects, the captured image data may be processed by the control system 922 to determine information indicative of plant health, a current phase of the plant lifecycle for the plants growing in the plant support apparatuses 904, germination of seedlings, maturation of seedlings, and so forth. In some aspects, the control system 922 may be configured to monitor the growth of the plants in the plant support apparatuses 904 based on the captured image data. In some aspects, the control system 922 may use machine learning methods to develop and/or refine methods for determining plant health, plant lifecycle phase, and so forth based on the captured image data. In some aspects, the control system 922 may be configured to determine the Normalized Difference Vegetation Index (NDVI) of the plants growing in the plant support apparatuses 904.

As shown in FIGS. 9, 10, and 13, the irrigation system may include a reservoir 952, supply piping 956, a plurality of emitters 960 (FIG. 11), runoff collection troughs 964, return piping 968, and one or more pumps 972. In accordance with one aspect, the components of the irrigation system may be dispersed throughout the cultivation module 800 and the support module 802. A nutrient dosing and monitoring system 976 may also be engaged with various components of the irrigation system 912, as is described in detail below. In some aspects, the irrigation system 912 may be a closed loop system.

The reservoir 952 may be configured to hold water and/or a mixture of water and nutrients to be delivered to the plants (e.g., via the emitters 960) and runoff from the plant support apparatuses 904 (e.g., delivered via the return piping 968). The reservoir 952 may be coupled to the supply piping 956, the return piping 968, and the pump 972. The pump 972 may be configured to pump water from the nutrient reservoir 952 into the supply piping 956. The reservoir 952 may be coupled to a water inlet 980 configured to receive water from a water source, such as a municipal water supply, a well, and so forth. The reservoir 952 may also be coupled to a drainage outlet 984. In some aspects, the drainage outlet 984 may be remotely actuated (e.g., by the control system 922).

The supply piping 956 may include a first end coupled to the nutrient reservoir and a second end coupled to the plurality of emitters 960 (FIG. 11). In aspects in which the plant support apparatuses 904 include the substantially vertical grow channels 928, the emitters 960 may be configured to deliver the mixture of water and nutrients to a first (or top) end of the vertical grow channels 928. The mixture of water and nutrients may then travel through the vertical grow channel 928 (e.g., via gravity) until it reaches the second (or bottom end) of the vertical grow channel 928. Plants 932 positioned in the grow channel 928 may absorb a portion of the mixture of water and nutrients as it passes through the vertical grow channel 928. In aspects in which the plant support apparatuses 904 are movable, a portion of the supply piping 956 may be flexible. In aspects in which the support apparatuses 904 include the substantially horizontal shelves, the emitters 960 may be configured to deliver the mixture of water and nutrients to the shelves. The mixture of water and nutrients may trickle from upper shelves to lower shelves.

The return piping 968 may be configured to receive the mixture of water and nutrients and return it to the reservoir 952. In aspects in which the plant support apparatuses 904 include the substantially vertical grow channels 928, a collection trough 988 may be configured to receive the mixture of water and nutrients flowing out of the second ends of the vertical grow channels 928. The return piping 968 may be coupled to the collection trough 988 to transmit the mixture of water and nutrients back to the reservoir 952. In aspects in which the plant support apparatuses 904 include the substantially horizontal shelves, the collection trough 988 may be oriented beneath the substantially horizontal shelves to receive the mixture of water and nutrients from the shelves. In some aspects, a pump 990 may be coupled to the collection trough 988 to pump the mixture of water and nutrients back to the reservoir 952. In some aspects, the pump 990 may be a float-actuated pump that is configured to operate when an amount of the mixture of water and nutrients in the collection trough 988 exceeds a predefined threshold.

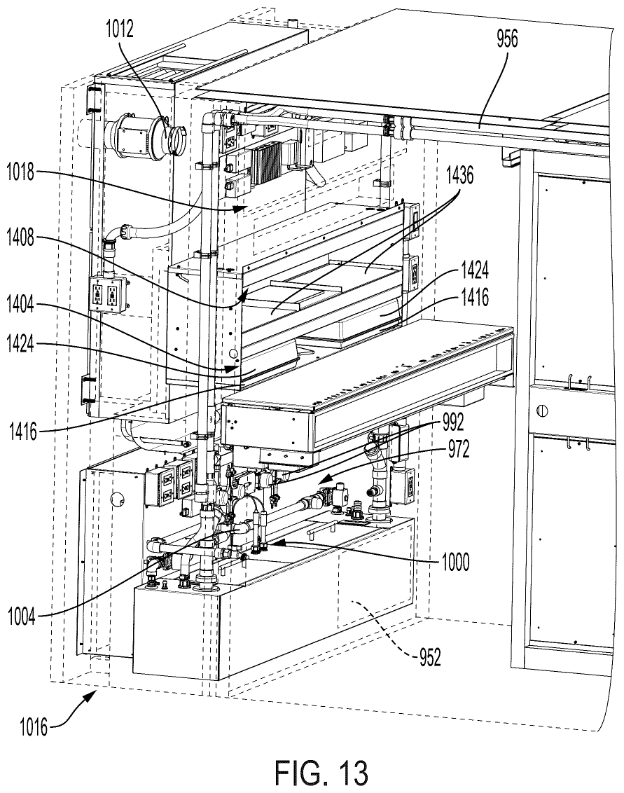

As shown in FIG. 13, the nutrient dosing and monitoring system 976 includes one or more nutrient dosers 992, one or more nutrient containers 996, and a plurality of sensors 1000. Each of the nutrient dosers 992 may be coupled to one of the nutrient containers 996 and be configured to dispense nutrients from the nutrient container 996 into the mixture of water and nutrients in the reservoir 952 and/or the piping 1004. Example nutrients include nitrate, potassium, calcium, and/or phosphorus. The nutrients may also include generally also include a broad variety of other micro and macronutrients beneficial for plant growth in addition to or instead of the example nutrients disclosed herein. In some aspects, one or more of the nutrient dosers 992 and nutrient containers may include pH-adjusting agents.

The plurality of sensors 1000 may include at least a pH sensor, an electrical conductivity sensor, and a temperature sensor. The pH sensor may be configured to determine a pH of the mixture of water and nutrients in the reservoir 952 and transmit the determined pH to the control system 922. The electrical conductivity sensor may be configured to determine an electrical conductivity of the mixture of water and nutrients in the reservoir 952 and transmit the determined electrical conductivity to the control system 922. In some aspects, the sensed electrical conductivity may be indicative of an amount of nutrients in the mixture of water and nutrients in the reservoir 952. In some aspects, the plurality of sensors 1000 may include sensors may be configured to identify (e.g., distinguish among) electrical conductivities corresponding to particular types of ions, which correspond to particular nutrients. Such sensors may include a membrane that only allows a particular type of ion to pass through. The sensors may be configured to determine the electrical signal due the particular ion that can cross the membrane. Example ions may include nitrate, calcium, and phosphorus ions, among others.

In some aspects, the nutrient dosing and monitoring system 976 may be configured to direct a portion of the mixture of water and nutrients into piping 1004 (FIG. 13). In such aspects, the sensors 1000 may be configured to analyze the mixture of water and nutrients in the piping 1004, as described in greater detail below. The nutrient dosers 992 may receive a command to provide one or more nutrients to the mixture of water and nutrients in the piping 1004, as described in greater detail below. The nutrient-rich mixture of water and nutrients may then be returned to the reservoir 952 by the piping 1004. In other aspects, the sensors 1000 may analyze the water in the nutrient reservoir 952 directly. In other aspects, the nutrient dosers 992 may be configured to provide one or more nutrients to the mixture of water and nutrients into the reservoir 952 directly.

The control system 922 may be communicatively coupled to the sensors 1000 and be configured to issue a command to the dosers 992 to adjust an amount of nutrients and/or other additives provided to the mixture of water and nutrients in the reservoir 942 based on information determined by the sensors 1000. For example, the control system 922 may receive the determined pH of the mixture of water and nutrients in the reservoir 952 and compare the determined pH to a predefined pH threshold. As used herein, the word “threshold” may refer to a single value or to a range of values. In response to determining that the determined pH falls outside of the predefined pH threshold, the control system 922 may issue a command to the dosers 992 to add a pH adjusting additive to the mixture of water and nutrients in the piping 1004. The control system 922 may receive the determined electrical conductivity of the mixture of water and nutrients in the piping 1004 and compare the determined electrical conductivity to a predefined threshold. In response to determining that the electrical conductivity is below the predefined threshold, the control system 922 may issue a command to the dosers 992 to add more nutrients to the mixture of water and nutrients in the piping 1004. In some aspects, the nutrients may be added according to a predefined ratio. In aspects in which the controller 922 may receive determined electrical conductivities due to different types of ions, the control system 922 may compare the determined electrical conductivity due to each type of ion to a predefined threshold corresponding to that particular ion. In response to determining that the electrical conductivity for a particular ion is below the predefined threshold, the controller may issue a command to the dosers 992 for a nutrient corresponding to that particular ion to add more of that particular nutrient to the reservoir 952.

In some aspects, the control system 922 may be configured to determine an amount of nutrients consumed by the plants based on an electrical conductivity of the mixture of water and nutrients. The control system 922 may be configured to determine information indicative of a health of the plants, a phase of the plant lifecycle of the plants, and so forth, based on the amount of nutrients consumed by the plants. In some aspects, the control system 922 may be configured to notify an operator of the farm container 100 (e.g., via an error message, a short message service (SMS) message, a multimedia message service (MMS) message, an email, an audible alarm, an optical indication, and so forth) in response to determining that the plants are in poor health. In some aspects, the control system 922 may be configured to notify an operator of the farm container 100 (e.g., via an error message, an SMS message, an MMS message, an email, an audible alarm, an optical indication, and so forth) in response to determining that the plants have progressed to another phase of the plant lifecycle.

In some aspects, the control system 922 may be configured to provide different amounts of nutrients to the mixture of water and nutrients and/or maintain a particular pH of the mixture of water and nutrients based on a lifecycle phase of the plants. For example, the control system 922 may be configured to use different pH and nutrient thresholds during different phases of the plant life cycle. The control system 922 may be configured to determine a current phase of the lifecycle of the plants based on information input by an operator of the farm container via a user input/output interface, an amount of item that has passed since the plant seedlings were planted, images of the plants captured by the camera(s) 1012, and so forth. In some aspects, the control system 922 may be configured to change a ratio at which the nutrients are provided in response to determining that the plants have progressed to another phase of the plant lifecycle.

In some aspects, the control system 922 may include (e.g., in the memory of the control system 922) or may be configured to access (e.g., from a networked device) a database of recipes. The database of recipes may include target thresholds of amounts or ranges of amounts of individual nutrients, target nutrient ratios, target pH thresholds, target humidities, target temperatures, lengths of light/dark cycles, wavelengths of light provided, and so forth. In some aspects, the recipes may be customized for a particular type of plant, groups of plants with similar nutritional needs, a phase in the lifecycle of the plant, and so forth. In some aspects, the recipes may be customized to deliver one or more particular characteristics, such a flavor profile, a color, a texture, and so forth for a particular type of plant. In such aspects, the control system 922 may be configured to issue a command to the dosers 992 to provide nutrients to the reservoir 952 and/or the piping 1004 according to a particular recipe. In some aspects, the control system 922 may also be configured to issue a command to the dosers 992 to maintain the pH of the nutrient reservoir 952 and/or the piping 1004 according to a particular recipe.

As shown in FIGS. 8-9, in some aspects, the bulkhead compartment 1016 may include equipment of the support module 802, such as an electrical box 918, components of the climate control system 920, components of the irrigation system 912, such as the reservoir 952, the nutrient dosers 992, the nutrient containers 996, the pump 972, and the control system 922. The bulkhead 1018 may also form a portion of the user workspace 924, which may include a work surface that can be used for transplanting seedlings, and so forth.

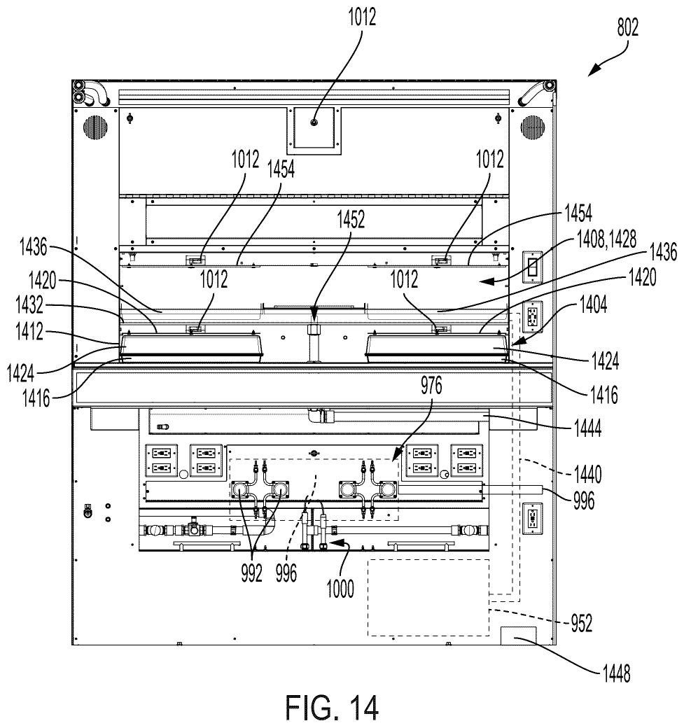

As shown in FIG. 14, in some aspects, the support module 802 may include a germination zone 1404 and a nursery zone 1408. In one aspect, the germination zone 1404 may not be coupled to the irrigation system 922. In another aspect, the germination zone 1404 may be coupled to the irrigation system 922. In such aspects, the germination zone may be coupled to the irrigation reservoir 952 by supply and drain piping, and a pump may pump the mixture of water and nutrients into the germination zone, which may add some life cycle flexibility. The germination zone 1404 may include a cavity or recess 1412 configured to receive one or more seeded germination trays 1416. One or more light panels 1420 may be mounted within the germination zone 1404. In some aspects, the light panels 1420 may be configured to provide full spectrum, lower power light to the germination trays 1416. In some aspects, one or more cameras 1012 may be mounted within the germination zone 1404. An operator of the mobile farm 100 may be able to view the images captured by the one or more cameras 1012 mounted within the germination zone 1404 to monitor the seeds to determine whether germination has occurred, to determine whether the germinated seedlings are mature enough to transplant into the seedling trays 1436 of the nursery zone 1408, and so forth. In some aspects, the control system 922 may be configured to monitor the image data captured by the one or more cameras 1012. In such aspects, the control system 922 may determine, based on the image data, whether germination has occurred, whether the germinated seedlings have matured, a change in health of the seedlings, and so forth, and notify the operator of that germination, maturation, and/or a change in health of the seedlings.

In the illustrated configuration, the germination trays 1414 are covered with clear covers 1424 to maintain a humid environment around the seeds. The seeded trays 1416 may remain in the germination zone 1404 until germination has occurred and the germinated seeds are mature enough to be moved into the nursery zone 1408.

In some aspects, the nursery zone 1408 may include a cavity or recess 1428 including an irrigation tray 1432 configured to receive one or more seedling trays 1436. The irrigation tray 1432 may be coupled to the reservoir 952, for example by supply piping 1440, return piping 1444, and a pump 1448. In some aspects, the seedling trays 1436 may be irrigated according to an ebb and flow process. For example, the pump 1448 may be configured to pump the mixture of water and nutrients from the reservoir 952 to the irrigation tray 1432. The control system 922 may then close a supply valve positioned along the supply piping 1440. The mixture of water and nutrients may remain in the irrigation tray 1432 for a predetermined dwell time. In some aspects, after the predefined dwell time has lapsed, the control system 922 may open a return valve positioned along the return piping 1444, allowing the mixture of water and nutrients to return to the reservoir 952. After expiration of a second dwell period, the control system 922 may again command the pump 1448 to pump the mixture of water and nutrients into the irrigation tray 1432. In some aspects, this ebb and flow irrigation process may be repeated according to a schedule. In some aspects, there is no independent return valve and the mixture water of water and nutrients is returned to the reservoir 952 via a much smaller orifice than the supply piping 1440, providing a flow differential that allows the level of the mixture of water and nutrients in the irrigation tray 1432 to be controlled.

In some aspects, the irrigation tray 1432 may include a passive overflow drainage system 1452. The passive overflow drainage system 1452 may be positioned within the irrigation tray 1432 and configured to drain any of the mixture of water and nutrients that exceeds a high water position into the reservoir 952. The passive overflow drainage system 1452 may prevent the irrigation tray 1432 from overflowing.

One or more light panels 1454 may be mounted within the nursery zone 1408. In some aspects, the light panels 1454 may be configured to provide light to the seedling trays 1436. In some aspects, the light panels 1454 may include LED lights. In some aspects, the light panel 1454 may include alternate banks of red and blue lights. In some aspects, one or more cameras 1012 may be mounted within the nursery zone 1408. An operator of the mobile farm 100 may be able to view the images captured by the one or more cameras 1012 mounted within the nursery zone 1408 to monitor the seedlings to whether the seedlings are mature enough to plant in the plant support apparatuses 904, whether a health of the seedlings has changed, and so forth. In some aspects, the control system 922 may be configured to monitor the image data captured by the one or more cameras 1012. In such aspects, the control system 922 may determine, based on the image data, seedlings have matured, a change in health of the seedlings, and so forth, and notify the operator of that maturation, and/or a change in health of the seedlings.

The climate control system 920 may be configured to measure and control humidity, carbon dioxide levels, temperature, and other related environmental factors. The climate control system 920 may include heating, ventilation, and air conditioning (HVAC) equipment can include an air conditioner, dehumidifier, and/or a fan, among other climate control elements. The climate control system 920 may include a plurality of sensors, such as temperature sensors, humidity sensors, carbon dioxide (CO₂) sensors, and so forth. The dehumidifier can remove the ambient moisture, condense the moisture, filter it and recycle it back into the farm's water supply. The dehumidifier can be stand-alone or integrated into the air conditioning unit. The fan may be configured to circulate conditioned air throughout the interior of the farm container 100. In some aspects, components of the climate control system 920 may be modular so that such components can be removed and replaced by the operator of the farm container 100 based on the climate requirements of the particular plants being grown in the farm container 100. For example, carbon filters may be added to the HVAC equipment of the climate control system 920 in farm containers 100 configured to grow cannabis plants.

In some aspects, conditioned air may be provided to the farm container via one or more vents 1020 (FIGS. 8 and 10) in the bulkhead 1018. In such aspects, a return 1024 may be positioned in a duct 1028 near an end of the duct 1028 furthest from the bulkhead 1018. In some aspects, the return 1024 may be on an underside of the duct 1028. Arrows B indicate a flow path of conditioned air within the farm container 100, according to some aspects.

In some aspects, the control system 922 may be configured to control a flow rate and timing of air flow to provide a suitable air circulation pattern. The air flow control system can receive data from various temperature sensors within the container. The air flow control system can be in communication with the HVAC equipment described herein for control thereof.

FIG. 15 illustrates an example graphical user interface (GUI) 1500 that may be displayed to an operator of the farm container 100. 1504 shows example image data captured by a camera 1012 mounted to a wall of a bulkhead compartment 1016 of the cultivation module 800. 1508 shows example image data captured by the camera 1012 mounted to one of the light panels 908. 1508 provides a view of the plants growing in a plant support apparatus 904 adjacent to the camera 1012. An operator may view this image data to determine health of the plants, a growth phase of the plants, and so forth. The buttons 1512, 1516 may allow the user to pan along a length of the plant support apparatus 904. Graphics 1520 may provide information indicative of environmental conditions of an interior of the farm container 100. For example, the graphics 1520 may provide information indicative of carbon dioxide (CO₂) concentration, temperature, percentage humidity, and/or dew point of the air within the farm container 100, among other information. The graphics 1520 may also provide information indicative of a pH and/or an electrical conductivity of the mixture of water and nutrients in the return piping 968 and/or the reservoir 952.

FIG. 15A illustrates an example GUI 1520 that may be displayed to an operator of the farm container 100. 1524 shows image data of the outside environment of the farm container 100. 1520 may include information indicative of the outside environment of the farm container 100, such as, for example, a current outside temperature, a chance of rain, a carbon dioxide concentration, and so forth. 1528 shows example image data captured by a camera mounted within the germination zone 1404. In some aspects, 1528 includes arrows that may be selected to toggle between image data captured by other cameras such as, for example, a camera mounted within the nursery zone 1408. 1532 shows example image data of the cultivation module 800 captured by one or more of the cameras 1016 mounted within the cultivation zone 800 or to the support module 804. In some aspects, 1532 includes arrows that may be selected to toggle between image data captured by other cameras 1016 mounted within the cultivation zone 800 or to the support module 804. 1532 may include information indicative of the inside environment of the farm container 100, such as, for example, a current inside temperature, a current pH of the mixture of water and nutrients in the irrigation system 922, a current electrical conductivity of the mixture of water and nutrients in the irrigation system 922, and so forth. 1536 shows summary information of a water level of the reservoir 952. In other aspects, 1536 may show summary information for other subsystems of the support module 804 and/or the cultivation module 800. 1540 shows summary information of pressure history for the pumps 972 of the irrigation system 912. In other aspects, 1540 may show summary information for other subsystems of the support module 804 and/or the cultivation module 800.

FIG. 15B illustrates an example GUI 1544 that may be displayed to an operator of the farm container 100. 1548 shows image data of the outside environment of the farm container 100. 1548 may display a menu providing a list of subsystems of the cultivation module 800 and/or the support module 804 to turn on or off. In some aspects, the menu may indicate whether listed subsystems are manually operated or automatically operated (e.g., by the control system 922). In the example of 1548, the subsystems include the HVAC heating subsystem, the HVAC cooling subsystem, the exhaust fan, and the carbon dioxide regulator. In other aspects, more or fewer subsystems of the cultivation module 800 and/or the support module 804 may be shown at 1548. 1552 shows example image data captured by a camera mounted within the germination zone 1404. In some aspects, 1552 includes arrows that may be selected to toggle between image data captured by other cameras such as, for example, a camera mounted within the nursery zone 1408. 1552 may display a menu providing a list of subsystems of the cultivation module 800 and/or the support module 804 related to the germination zone 1404 and/or the nursery zone 1408 to turn on or off. In some aspects, the menu may indicate whether listed subsystems are manually operated or automatically operated (e.g., by the control system 922). In the example of 1552, the subsystems include the work lights, the lights 1420, and the pump 1448. In other aspects, more or fewer subsystems of the cultivation module 800 and/or the support module 804 may be shown at 1550. 1556 shows example image data of the cultivation module 800 captured by one or more of the cameras 1016 mounted within the cultivation zone 800 or to the support module 804. In some aspects, 1556 includes arrows that may be selected to toggle between image data captured by other cameras 1016 mounted within the cultivation zone 800 or to the support module 804. 1556 may display a menu providing a list of subsystems of the cultivation module 800 and/or the support module 804 to turn on or off. In some aspects, the menu may indicate whether listed subsystems are manually operated or automatically operated (e.g., by the control system 922). In the example of 1548, the subsystems include the work lights, the pumps 972 of the irrigation system 912, and controls for groups of the light panels 908. In other aspects, more or fewer subsystems of the cultivation module 800 and/or the support module 804 may be shown at 1548.

In some aspects, the farm container 100 may not be used to germinate seedlings. Instead, the seedlings may be provided by a seedling subscription service. After an initial set-up process, seedlings may be automatically provided to a user of the farm container 100 when a current crop of plants in the farm container 100 is ready to harvest. The user may be able to access the seedling subscription service through a computing system, hereinafter referred to as a subscription system 1502 (FIG. 9), such as a desktop computer or a mobile computer, via a software application, a website, and so forth.

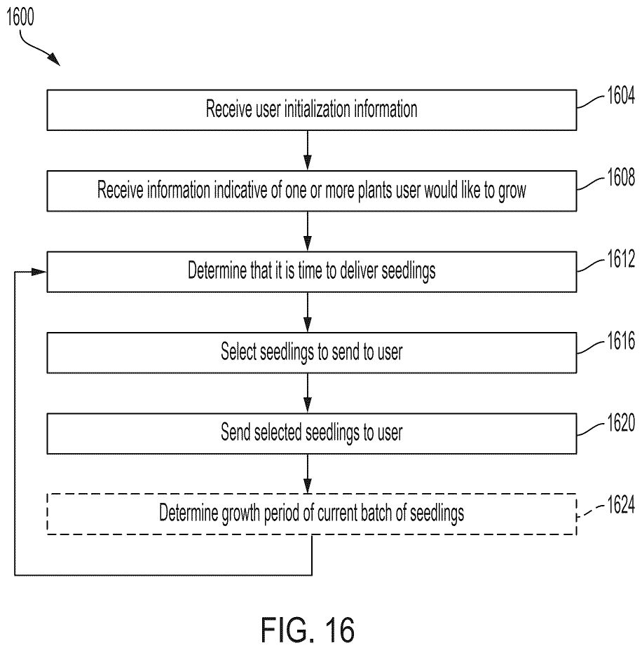

An example method 1600 for automatically providing seedlings to a user is shown and described with respect to FIG. 16. At 1604, the subscription system 1602 may receive user initialization information. Example initialization information may include information indicative of a number of plant support apparatus 904 in the user's farm container 100, a type of plant support apparatus 904 in the user's farm container, and so forth. In some aspects, the user may enter the initialization information into the subscription system 1602. In some aspects, the control system 922 may be configured to transmit the initialization information to the subscription system 1602.

At 1608, the subscription system 1602 may receive information indicative of one or more particular plants that the user would like to grow. In some aspects, the user may provide an order in which the user would like to receive the one or more particular plants. In some aspects, the user may establish a rotation of groups of plants that the user would like to receive. In some aspects, the user may also provide desired characteristics for the produce of the particular plants. Example characteristics may include flavor profile, texture, color, absence of seeds, and so forth.

At 1612, the subscription system 1602 may determine that it is time to send seedlings to a particular user. In some aspects, the subscription system 1602 may determine that it is time to send seedlings to a first-time user after the user has enrolled into the subscription service. In some aspects, for existing customers, the subscription system 1602 may determine that it is time to send seedlings after a determined growth period for a previous batch of seedlings has expired. In some aspects, the subscription system 1602 may be configured to receive image data of the plants growing in the farm container 100 (e.g., image data captured by the camera(s) 1012) or receive information indicative of a phase of the plant lifecycle of the plants in the farm container 100, etc. In some aspects, the subscription system 1602 may be configured to determine, based on the received image data or information indicative of the phase of the plant lifecycle, that the present crop of plants in the plant support apparatuses 904 is ready for harvest and/or has been harvested, and determine that it is therefore time to send seedlings to the user.

At 1616, the subscription system 1602 may select seedlings to send to the user. In some aspects, the subscription system 1602 may select seedlings based on a position of a particular plant on the list provided by the user at 1608. In some aspects, the subscription system 1602 may group plants from the list provided by the user at 1608 that have similar growing conditions together so that such plants may be grown at the same time, and select such a group to send to the user.

At 1620, the subscription system 1602 may send the selected seedlings to the user. In some aspects, the subscription system 1602 may send instructions (e.g., with the seedlings or via a network) to the control system 922 to execute a particular recipe corresponding to the selected seedlings. The particular recipe may include particular nutrient ratios and/or concentrations, pH ranges, environmental conditions, and so forth to produce the desired characteristics for the produce of the particular plants.

In some aspects, at 1624, the subscription system 1602 may determine the growth period of the current batch of seedlings sent to the user. In some aspects, the subscription system 1602 may determine the growth period based on one or more of a transit time for the seedlings to reach the user, a type of plant being grown, and so forth. In other aspects, such as aspects in which the subscription receives captured image data from the camera(s) 1012, the subscription system 1602 may skip step 1624. The subscription system may then repeat blocks 1612-1620 or 1612-1624 until all of the plants on the list have been provided, the user cancels the subscription service, and so forth.

In some aspects, after the initial initialization steps (e.g., 1604 and/or 1608) have been completed, the process 1600 may be able to run without further intervention by the user.

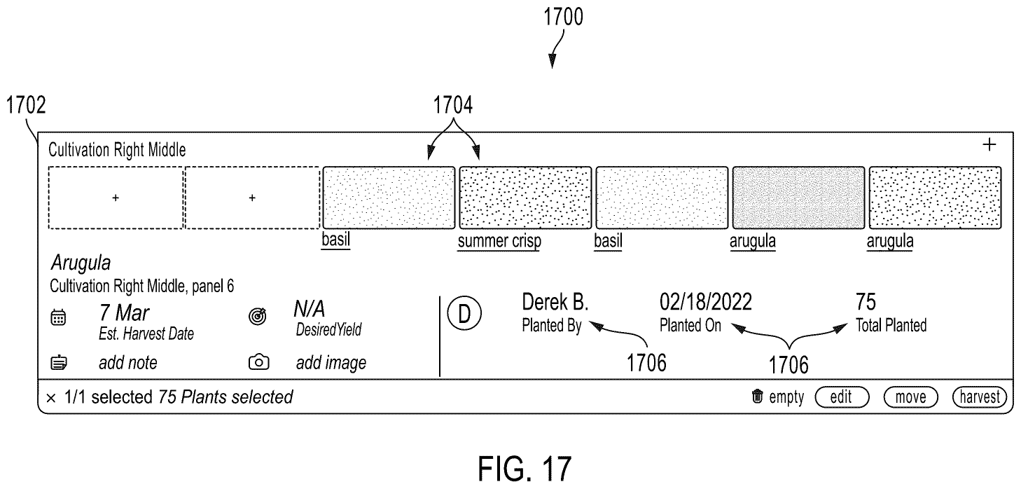

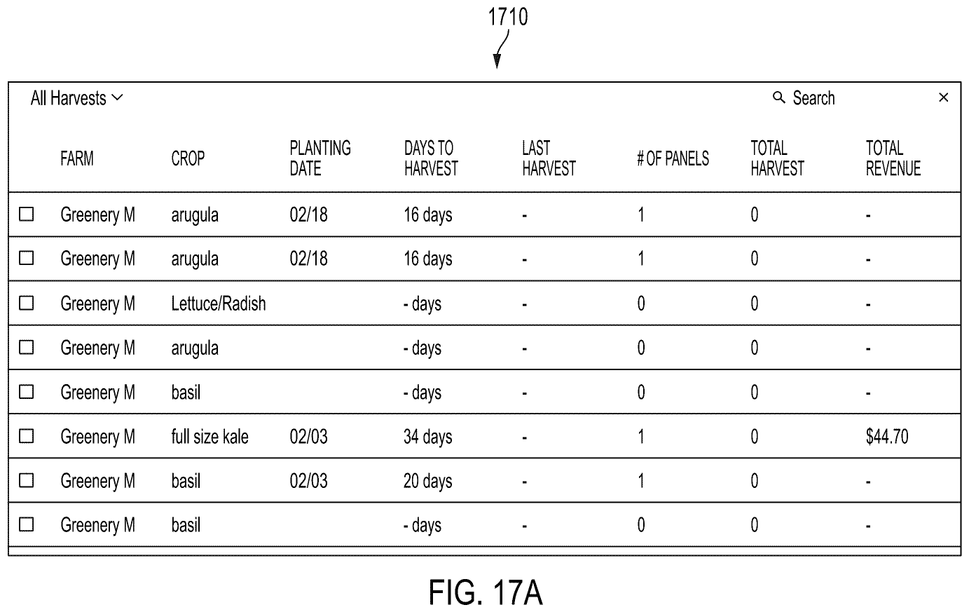

FIG. 17 illustrates an example GUI 1700 for a crop planning feature that may be displayed to an operator of the farm container 100. Row 1702 illustrates an example schematic representation of the plants growing in a particular plant support apparatus 904 of the farm container 100 in which portions of the plant support apparatus 904 are indicated by boxes 1704. In some aspects, the identities of the plants growing in the portions of the plant support apparatus 904 indicated by the boxes 1704 may be entered by the user of the farm container 100. In some aspects, the identities of the plants growing in the portions of the plant support apparatus 904 indicated by the boxes 1704 may be entered by the control system 922 without user intervention. For example, the control system 922 may be configured to determine the identities of the plants growing in the portions of the plant support apparatus 904 based on image data captured by the camera 1012 facing the plant support apparatus 904. Although the example GUI 1700 only illustrates one row 1702, in other aspects, the GUI 1700 may show a row 1602 corresponding to each of the plant support apparatuses 904 in the farm container 100.

The GUI 1700 may include further information regarding the plants represented by the boxes 1704, which may be accessed by selecting a particular box 1704. Such information may include a date the plants were planted, an amount of plants planted, which user planted the plants, a predicted harvest date, and so forth. In the example of FIG. 17, the box 1704 corresponding to “arugula” has been selected, and is displayed at 1706. In some aspects, information such as the information provided in the display 1700 may be used by the subscription system 1602 for demand planning. For example, the subscription system 1602 may be configured to send the seedlings so that the seedlings arrive on the same day as the plants currently growing in the farm container 100 are due to be harvested, thereby reducing the amount of down time of the farm container 100.

Providing seedlings to a user may be advantageous for several reasons. Providing seedlings to users (instead of having the user germinate their own seeds) may reduce the amount of work for the user. Further, providing seedlings to a user may reduce the complexity of the farm container 100, because the cultivation module 800 may not need to include any components optimized for germination (as opposed to plant cultivation). Further, since the specific identities of the seeds used to produce the seedlings may be known, recipes adapted to produce the desired characteristics for the cultivation of the particular plants can be used.

FIG. 17A illustrates another example GUI 1710 for a crop planning feature that may be displayed to an operator of the farm container 100. The GUI 1710 may be configured to display information regarding the crops planted in the farm container 100. Such information may include a location of the crop (e.g., the “farm” column), a type of plant, a plant date, a harvest date, a date that type of crop was last harvested, an amount of plants planted for that particular crop (e.g., in “#of panels” column), a total amount harvested, and a total revenue earned by the harvested crops. In some aspects, information such as the information provided in the display 1710 may be used by the subscription system 1602 for demand planning. For example, the subscription system 1602 may be configured to send the seedlings so that the seedlings arrive on the same day as the plants currently growing in the farm container 100 are due to be harvested, thereby reducing the amount of down time of the farm container 100. This also prevents seedlings from arriving too early to be transplanted in the plant support apparatuses 904. Seedlings that are not transplanted shortly after arrival may not grow as well as they would have if they had been transplanted shortly after arrival.

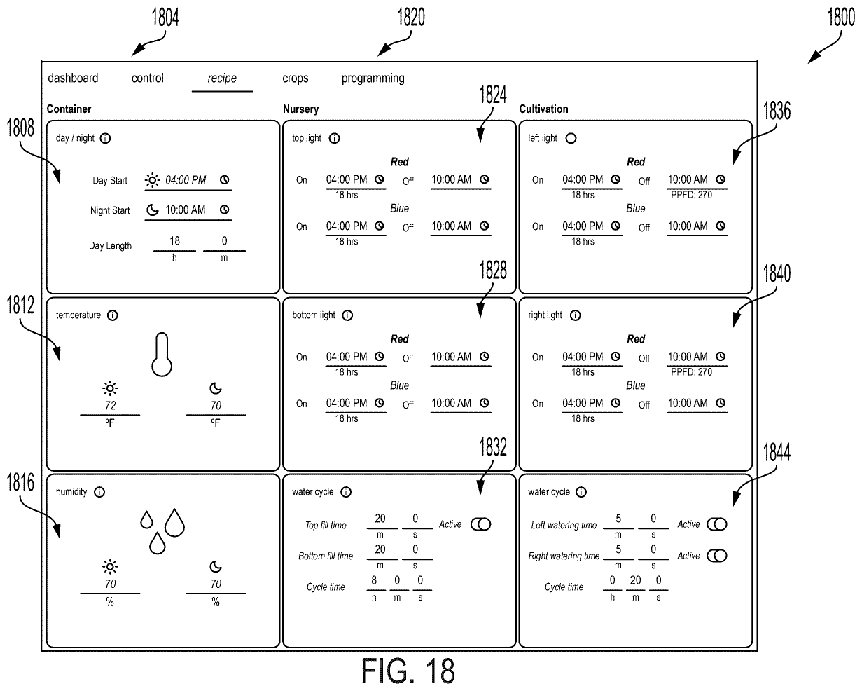

FIG. 18 illustrates an example GUI 1800 for viewing, establishing, or changing one or more recipes used in the farm container 100. The GUI 1800 may be configured to display information indicative of the operating conditions of the farm container 100 in column 1804. For example, day length information is shown at 1808. Example day length information may include a day start time, a day end time, and a day length. In another example, temperature information is shown at 1812. Example temperature information may include a target daytime temperature or range of daytime temperatures and a target nighttime temperature or range of temperatures for the farm container 100. In another example, humidity information is shown at 1816. Example temperature information may include a target daytime humidity or range of daytime humidities and a target nighttime humidity or range of humidities for the farm container 100.

The GUI 1800 may be configured to display information indicative of the operating conditions of the nursery zone 1408 and/or the germination zone 1404 in column 1820. For example, in aspects in which the light panels 1454 in the nursery zone 1408 are configured to provide red and/or blue light to the seedlings, the on and off times for the red lights and/or at the blue lights is shown at 1824, 1828. In some aspects, 1824 may refer to the nursery zone 1408 and 1828 may refer to the germination zone 1404. In another example, information indicative of a cycle of the irrigation system 912 may be shown at 1832. In some aspects, the dwell time in which the irrigation tray 1432 has been filled with the mixture of water and nutrients may be shown at 1832. In some aspects, a cycle time may be shown at 1832. In some aspects, the operator may be able to turn off components of the irrigation system 912 at 1832. For example, 1832 shows a slider that allows the operator to toggle between “active” and “inactive” for the portion of the irrigation system 912 coupled to the nursery zone 1408.

The GUI 1800 may be configured to display information indicative of the operating conditions of the cultivation module 800 in column 1834. For example, in aspects in which the light panels 908 in the cultivation module 800 are configured to provide red and/or blue light to the plant support apparatuses 904, the on and off times for the red lights and/or at the blue lights is shown at 1836, 1840. In some aspects, 1836 may refer to light panels 908 positioned on a first side of the cultivation module 800 and 1840 may refer to the light panels 908 positioned on a second side of the cultivation module 800. In another example, information indicative of a cycle of the irrigation system 912 may be shown at 1844. In some aspects, the length of a watering time period may be shown at 1844. In some aspects, a cycle time may be shown at 1844. In some aspects, the operator may be able to turn off components of the irrigation system 912 at 1844. For example, 1844 shows a slider that allows the operator to toggle between “active” and “inactive” for the portion of the irrigation system 912 coupled to the plant support apparatuses 904 in the first side of the cultivation module 800 and a slider that allows the operator to toggle between “active” and “inactive” for the portion of the irrigation system 912 coupled to the plant support apparatuses 904 in the second side of the cultivation module 800.

In some aspects, the GUI 1800 may allow an operator to change aspects of the recipes, for example, by selecting a particular parameter to edit and then changing the parameter, for example by a text entry box, a drop-down menu, and so forth. In some aspects, the GUI 1800 may include on/off switches that let the operator turn on or off subsystems described in the recipe.

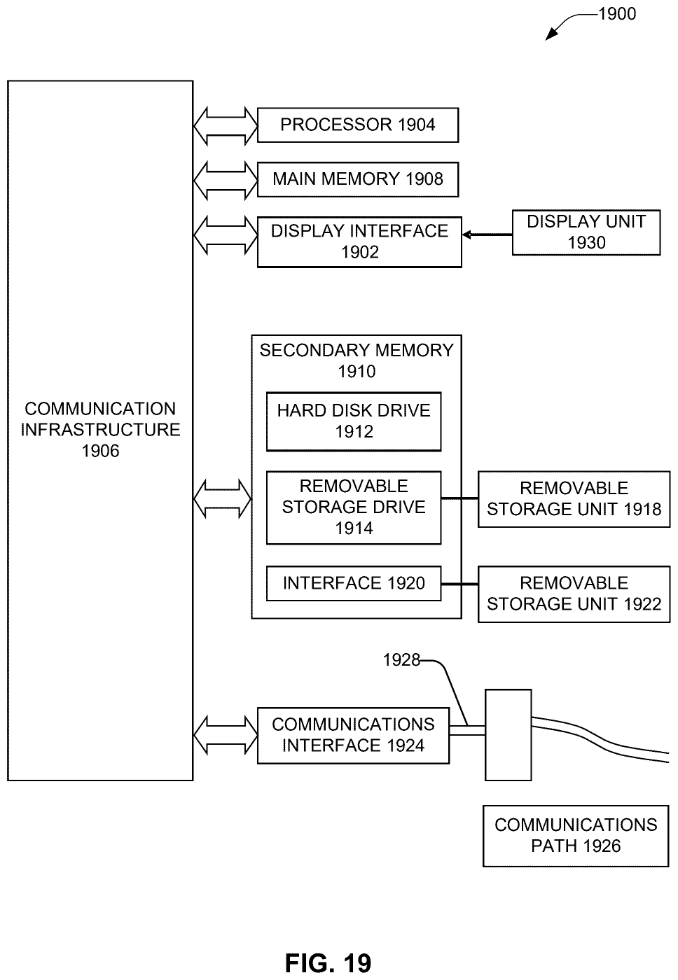

FIG. 19 presents an example system diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein of the farm container 100. An example of such a computer system 1900 is shown in FIG. 19.

The computer system 1900 includes one or more processors, such as processor 1904. The processor 1904 is connected to a communication infrastructure 1906 (e.g., a communications bus, cross-over bar, or network). The processor 1904 may include a processor for any of the local controller 922 of FIG. 9. Various software aspects are described in terms of this example computer system. After reading this description, it will become apparent to a person skilled in the relevant art(s) how to implement aspects described herein using other computer systems and/or architectures. The subscription system 1602 may be or include a computer system similar to the computer system 1900.

Computer system 1900 may include a display interface 1902 that forwards graphics, text, and other data from the communication infrastructure 1906 (or from a frame buffer not shown) for display on a display unit 1930. Computer system 1900 also includes a main memory 1908, preferably random access memory (RAM), and may also include a secondary memory 1910. The secondary memory 1910 may include, for example, a hard disk drive 1912 and/or a removable storage drive 1914, representing a floppy disk drive, a magnetic tape drive, an optical disk drive, etc. The removable storage drive 1914 reads from and/or writes to a removable storage unit 1918 in a well-known manner. Removable storage unit 1918, represents a floppy disk, magnetic tape, optical disk, etc., which is read by and written to removable storage drive 1914. As will be appreciated, the removable storage unit 1918 includes a computer usable storage medium having stored therein computer software and/or data.

In alternative aspects, secondary memory 1910 may include other similar devices for allowing computer programs or other instructions to be loaded into computer system 1900. Such devices may include, for example, a removable storage unit 1922 and an interface 1920. Examples of such may include a program cartridge and cartridge interface (such as that found in video game devices), a removable memory chip (such as an erasable programmable read only memory (EPROM), or programmable read only memory (PROM)) and associated socket, and other removable storage units 1922 and interfaces 1920, which allow software and data to be transferred from the removable storage unit 1922 to computer system 1900. In an example, memory for the control system 922 may include the main memory 1908, the secondary memory 1910, the removable storage drive 1914, the removable storage unit 1918, the removable storage unit 1922, etc.

The computer system 1900 may also include a communications interface 1924. Communications interface 1924 allows software and data to be transferred between computer system 1900 and external devices. Examples of communications interface 1924 may include a modem, a network interface (such as an Ethernet card), a communications port, a Personal Computer Memory Card International Association (PCMCIA) slot and card, etc. Software and data transferred via communications interface 1924 are in the form of signals 1928, which may be electronic, electromagnetic, optical or other signals capable of being received by communications interface 1824. These signals 1928 are provided to communications interface 1924 via a communications path (e.g., channel) 1926. This path 1926 carries signals 1928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive, a hard disk installed in a hard disk drive, and/or signals 1928. These computer program products provide software to the computer system 1900. Aspects described herein may be directed to such computer program products.

Computer programs (also referred to as computer control logic) are stored in main memory 1908 and/or secondary memory 1910. Computer programs may also be received via communications interface 1924. Such computer programs, when executed, enable the computer system 1900 to perform various features in accordance with aspects described herein. In particular, the computer programs, when executed, enable the processor 1904 to perform such features. Accordingly, such computer programs represent controllers of the computer system 1900.

In variations where aspects described herein are implemented using software, the software may be stored in a computer program product and loaded into computer system 1900 using removable storage drive 1914, hard disk drive 1912, or communications interface 1920. The control logic (software), when executed by the processor 1904, causes the processor 1904 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

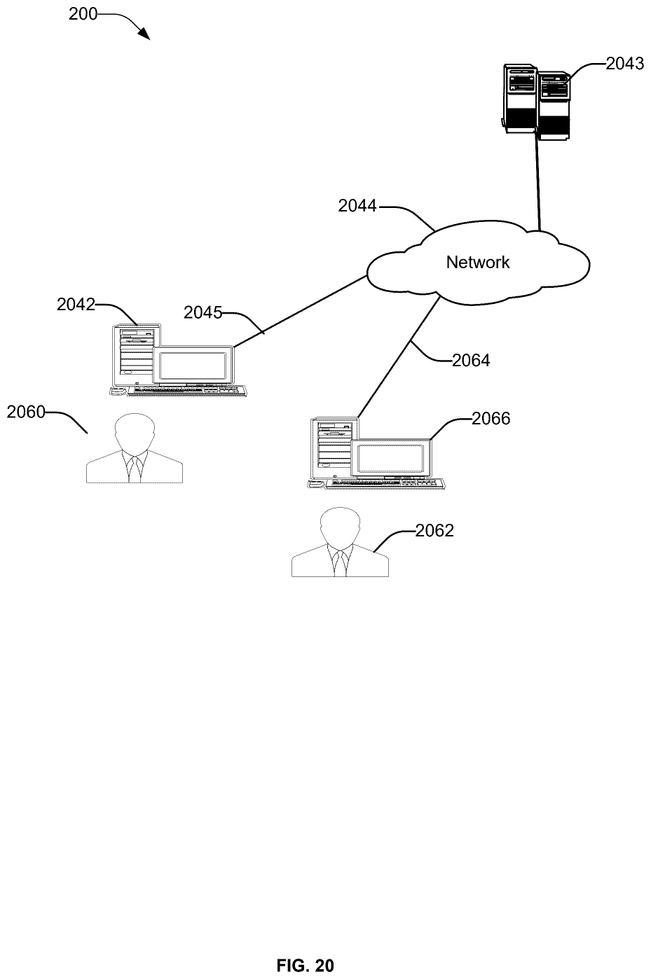

FIG. 20 is a block diagram of various example system components for use in accordance with aspects of the present disclosure. FIG. 20 shows a communication system 2000 usable in accordance with aspects described herein. The communication system 2000 may include one or more users 2060, 2062 and one or more terminals 2042, 2066. For example, terminals 2042, 2066 may include the control system 922 or the subscription system 1602 or a related system, and/or the like. In one aspect, data for use in accordance with aspects described herein is, for example, input and/or accessed by users 2060, 2062 via terminals 2042, 2066, such as personal computers (PCs), minicomputers, mainframe computers, microcomputers, telephonic devices, or wireless devices, such as personal digital assistants (“PDAs”) or a hand-held wireless devices coupled to a server 2043, such as a PC, minicomputer, mainframe computer, microcomputer, or other device having a processor and a repository for data and/or connection to a repository for data, via, for example, a network 2044, such as the Internet or an intranet, and couplings 2045, 2046, 2064. The couplings 2045, 2046, 2064 include, for example, wired, wireless, or fiberoptic links. In another example variation, the method and system in accordance with aspects described herein operate in a stand-alone environment, such as on a single terminal.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A container farm comprising:
a cultivation module comprising:
at least one first plant support apparatus configured to receive one or more plants having a first configuration; and
a support module comprising:
an irrigation system configured to provide a mixture of water and nutrients to the at least one first plant support apparatus; and
a climate control system comprising components of a heating, ventilation, and air conditioning (HVAC) system;
wherein the at least one first plant support apparatus is configured to be exchanged with at least one second plant support apparatus configured to receive one or more plants having a second configuration different than the first configuration; or one of the components of the HVAC system is configured to be replaced with a different component of the HVAC system.

2. The container farm of claim 1, wherein the first configuration comprises vertically-oriented plant grow channels.

3. The container farm of claim 1, wherein the second configuration comprises horizontally-oriented shelves.

4. The container farm of claim 1, further comprising:
a camera configured to capture image data of the one more plants growing in the first plant support apparatus; and
a controller comprising a processor and memory, the memory including computer-executable instructions executable by the processor to:
receive the captured image data;
determine, based on the captured image data one or more of a health of the one or more plants and a lifecycle phase of the one or more plants growing in the first plant support apparatus.

5. The container farm of claim 4, wherein the controller is configured to use machine-learning.

6. The container farm of claim 1, wherein the support module includes a nursery zone including an irrigation tray coupled to the irrigation system, the irrigation tray configured to receive one or more seedling trays therein.

7. The container farm of claim 6, wherein the nursery zone is positioned within a cavity in the support module and includes one or more lighting panels configured to provide light to the seedling trays.

8. The container farm of claim 7, wherein the cavity in the support module is a first cavity, and wherein the support module includes a germination zone configured to receive seeded trays of ungerminated seedlings therein, wherein the germination zone is positioned in a second cavity in the support module.

9. The container farm of claim 1, wherein the support module includes a germination including configured to receive seeded trays of ungerminated seedlings therein.

10. A computer-implemented method for providing one or more seedlings to a farm, the method comprising:
receiving captured image data of a plurality of plants growing in one or more plant support apparatuses of a farm;
determining, based on the captured image data, that it is time to deliver seedlings to a user of the farm; and
transmitting one or more seedlings to the user of the farm.

11. The method of claim 10, wherein determining, based on the captured image data, that it is time to deliver seedlings to a user of the farm includes determining, based on the captured image data, that the plurality of plants is ready to be harvested.

12. The method of claim 10, further comprising, refining, based on machine-learning techniques, the determination.

13. A container farm comprising:
one or more plant support apparatuses configured to receive one or more plants therein;
an irrigation system configured to provide a mixture of water and nutrients to the one or more plant support apparatuses, the irrigation system comprising:
first piping configured to transmit the mixture of water and nutrients to the one or more plant support apparatuses from a reservoir;
second piping configured to receive runoff from the one or more plant support apparatuses and transmit the runoff to the reservoir;
a sensor configured to determine an electrical conductivity of the mixture of water and nutrients; and
a nutrient dosing system configured to provide one or more nutrients to the mixture of water and nutrients; and
a controller comprising a processor and memory, the memory including computer-executable instructions executable by the processor to:
receive a determined electrical conductivity of the mixture of water and nutrients from the sensor;
determine, based on the determined electrical conductivity one or more of a health of the one or more plants and a lifecycle phase of the one or more plants growing in the one or more plant support apparatuses.

14. The container farm of claim 13, wherein the controller is configured to:
compare the determined electrical conductivity to a predetermined threshold; and
issue a command to the nutrient dosing system to provide the one or more nutrients to the mixture of water and nutrients in response to determining that the electrical conductivity is below a predetermined threshold.

15. The container farm of claim 13, wherein the controller is configured to:
compare the determined electrical conductivity to a predetermined threshold; and
issue a command to the nutrient dosing system to change a ratio at which the one or more nutrients are provided to the mixture of water and nutrients based on one or more of the determined health of the one more plants and a lifecycle phase of the one or more plants growing in the first plant support apparatus.

16. The container farm of claim 13, wherein the determined electrical conductivity is determined for a particular ion type and the controller is configured to:
compare the determined electrical conductivity to a predetermined threshold; and
issue a command to the nutrient dosing system to provide a particular nutrient corresponding to the particular ion type to the mixture of water and nutrients in response to determining that the electrical conductivity is below a predetermined threshold.

17. The container farm of claim 13, wherein the irrigation system comprises:
third piping configured to transmit the mixture of water and nutrients to an irrigation tray of a nursery zone configured to receive one or more trays of seedlings; and
fourth piping configured to receive runoff from the irrigation tray and transmit the runoff to the reservoir.

18. The container farm of claim 17, wherein the fourth piping is configured to drain runoff from the irrigation tray in response to a water level in the irrigation tray exceeding a predefined height.

19. The container farm of claim 18, wherein the controller is configured to:
receive a determined electrical conductivity of the mixture of water and nutrients from the sensor; and
determine, based on the determined electrical conductivity one or more of a health of the one or more plants and a lifecycle phase of the one or more plants growing in the seedling trays.

20. The container farm of claim 13, wherein the controller is configured to:
compare the determined electrical conductivity to a predetermined threshold; and
issue a command to the nutrient dosing system to provide the one or more nutrients to the mixture of water and nutrients according to a predefined recipe.
